(19) United States
(12) Patent Application Publication
(10) Pub. No.: US 2004/0080661 A1
(43) Pub. Date: Apr. 29, 2004

(54) Camera that combines the best focused parts from different exposures to an image

(76) Inventors: Sven-Ake Afsenius, Lidingo (SE); Jon Kristian Hagene, Dilling (NO)

Correspondence Address: ALBIHNS STOCKHOLM AB, BOX 5581, Linnegatan 2, SE-114 85 STOCKHOLM; Sweden, STOCKHOLM, SE

(21) Appl. No.: 10/450,913

(22) PCT Filed: Dec. 21, 2001
(86) PCT No.: PCT/SE01/02889

(30) Foreign Application Priority Data
Dec. 22, 2000 (SE) 0004836-3

(51) Int. Cl. H04N 5/232

(52) U.S. Cl. 348/345

(57) ABSTRACT

The object of the present invention is to eliminate hitherto restrictive conditions related to photography, like when attempting to register pictures with infinite depth of field, more or less, or attempt full detail-reproduction of light and shade. This is, according to the present invention, accomplished by making several recordings with differing states of focus or exposure, the images registered being similarly subdivided into smaller image-parts and a resultant image bing produced by selecting those image-parts from each set, being most suitable. Optimal image definition of an image-part can for instance be assessed by contrast-measurement techniques or separate range-finding with a laser. An analogous optimal representation of image detail can also be achieved.

The present invention refers to a camera with an image registration device in its image plane, preferably an electronic one like a CCD sensor. To be more specific, it's an electronic instrument with an objective lens, a pixel-oriented image detector with entrance surface, an electronic image memory for saving image information originating in the same detector and an automatic focusing device, according to a preferred mode of operation. The invention is furthermore referring to the corresponding methods, some of them applicable for (emulsion-) film cameras as well, however with a subsequent image process.

### PURPOSE OF THE INVENTION

The purpose of the present invention is to accomplish an instrument where hitherto restrictive conditions related to photography are removed more or less. A major such limitation is the practical impossibility to produce photos of high image definition for all ranges. And strictly speaking, it's equally difficult to attain short depths of field, suppressing image detail being outside this interval, such residual detail-blur manifesting another restriction. A third limitation of similar character, is associated with the frequently occurring situation of large intensity variations across a scene, usually in-between light and shade, making it impossible to register bright and dark areas in full detail.

It may be recalled that depth of field for standard photographic lenses depends upon relative aperture. However a significant stop will also degrade the feasible image resolution, due to wave properties of light. Another consequence of stopping down an objective is loss of light which however may become less conclusive due to high sensitivity characteristics of modem electronic pixel-oriented image registration.

To make pictures without being committed to these restrictions mentioned, has so far been reserved for the fine arts like sketching and painting more or less. This applies to depth of field, which is hardly regarded as a problem by an artist while scenes where well-lit and poorly illuminated or dark objects alternate, constitute another such example where some schools of the old classic arts excel. It's a purpose of the present invention to gain a corresponding freedom for photographers.

### PRIOR ART

A method to combine differently-focused pictures in order to produce a compound image with improved image definition, is disclosed by U.S. Pat. No. 4,661,986: A video signal registration takes place for each state of focus for a three-dimensional scene and frequency-spectra related to these video signals support a comparison, row by row across the pictures, enabling selection of optimal pixels. Even successively registered images with one and the same camera are described. A similar method and device is described in U.S. Pat. No. 6,201,899.

Several camera designs with automatic focusing devices (‘Autofocus’) and where the object is to adjust for a ‘best’ image definition, are known. One such design is measuring the time-lapse of an ultrasound pulse. Other systems work with contrast detection, where a focus-scan takes place and a setting for maximum contrast is assessed. The contrast is measured by two or several electronic sensors being mounted in a beamsplitter arrangement. The adjustment is performed for a minor select part of the image, usually in the middle. Such a camera, denominated Konica C35AF, was introduced around 1978 (cf. the periodical FOTO no. 1, 1978). Descriptions of similar systems may be found in U.S. Pat. Nos. 4,078,171 and 4,078,172. Adjustment of focus, according to these cases, is optimal for one range only, while objects falling outside this plane (or curved surface, i.e. where sharp reproduction takes place, answering to the contrast measurement), become blurred more or less, depending upon the spread of object-distances.

An entirely different objective lens design aiming at the movie industry and following U.S. Pat. No. 4,741,605, makes it possible to focus upon two (or a few more) different distances at the same time. One or several aperture lenses, are here inserted in order to cover part of the entrance aperture. Sharp image of a nearby object is created by placing this lens attachment in a favourable lateral position while the free aperture part is similarly depicting remoter objects. A drawback of this approach is that the ray path via the lens attachment is still creating a blurred, yet almost invisible, image of the remote object, while the other ray path through the unobstructed aperture creates a similarly blurred projection of nearby objects. These totally unfocused images are therefore contributing with ‘background illumination’, scattered over the image surface, thus as a consequence halving the image contrast more or less (i.e. for two images).

As to the other problem with photos having pronounced lights and shades, there are few remedies known, except for using the most optimal positive/negative film material/sensor and to protect against straylight wherever feasible. Paper copies are problematic while slides do somewhat better.

### SUMMARY OF THE INVENTION

To sum up, this and other objects and advantages of an electrooptical instrument, designed in accordance with the present invention and described in the introductory passage or further below, is attained by means of distinctive features mentioned in the descriptive parts of independent patent claims enclosed. Advantageous embodiments are further dealt with in the dependent claims. The invention may be summed up in brief albeit without restrictive purposes, as follows:

Several exposures, equivalent to the same several pictures, are made with various camera settings. Each of these pictures are similarly subdivided into many sub-image segments or image parts. Each such portion of a scene is thus to be found in one set of image parts, albeit recorded with variable camera settings. One image part from each such group is furthermore selected and merged into a whole resultant image. The subdivision into image parts or sub-images may be performed in different ways and this is also true about the kind of camera settings which are to be adjusted in-between exposures.

It's obvious for a specialist scrutinizing this invention that a multitude of variations are possible. Like the subdivision into segments/sub-images, which can be firm or adjustable for numerous patters. And the several exposures, subject to subsequent assembly, may also be differently focused. Object distances can be measured directly with ultrasound or laser-light for each image part. Time-lapse or parallax measurements are practicable. Another approach is to measure the contrast within each sub-image, this being a preferred mode of operation. In principle no telemetry is here involved. It's nevertheless possible to estimate the range for each object-element projected, from the objective lens setting corresponding to maximal contrast, this constituting a special effect, enabling a sort of three-dimensional registration of the scene. The subdivision into image parts can also be effectuated as a function of the scene itself, this constituting another attractive set-up for the contrast measurement procedure: A kind of background or reference image (like the infinitely-focused exposure of a set) is here assigned, however parts with higher contrast are successively replacing the low-contrast areas as the process goes on. Less image memory is consequently required, this being to advantage.

Various sophistication levels are conceivable when implementing the present invention. However technical solutions with minimal mechanical complications are sometimes at a premium, involving two or several fixed but differently-focused image sensors, located behind some beamsplitter system. Other designs may include a mobile or adjustable objective lens, viz. adjustable relative one image plane only. An undulating lens of that kind may prove less successful for cinematographic use however. A rotating disk with discrete steps of various thickness, may provide a better approach in that case.

No optimization of image definition nor focus takes place when photographing according to another modification of the present invention: Instead a camera records, preferably in fast sequence, several differently focused exposures. The subsequent image processing, including possible subdivision into sub-images, search for image parts with optimal resolution and final assembly of a resultant image, is now taking place in a separate unit. This modification is also applicable to other, non-digital sensor materials, like ordinary (emulsion-) film.

The image contrast C in-between two adjacent picture areas of intensities A and B, is here defined as an expression like C=A−B/A+B where A is bigger than B.

### BRIEF DESCRIPTION OF FIGURES

FIG. 1 shows a digital camera with beamsplitter D and two differently focused image planes. The objective OB is projecting a scene F onto image planes B1 and B2 with associated image sensors CCD1 and CCD2. A processing unit P is receiving image information from the two sensors. It's dividing the images into small image parts or sub-images, selecting and forwarding those having superior image definition, to memory M.

FIG. 2 displays a surveillance camera application

FIG. 3a is displaying an arrangement where focusing is effected by means of moving an objective lens.

FIG. 3b exhibits a similar design, except that range-finding applies to each little image part, this being decisive for a choice of optimally focused segment(s) from each set, thus no contrast measurements taking place here.

FIG. 4 shows another digital camera with objective lens OB, a variable illumination-limiting device (like an aperture stop) VS and an electronic sensor CCD registering images. An exposure meter E is furthermore dividing the image into parts i, i+1, i+2 . . . which are individually and differently exposed. There is finally an electronic image processing unit P which is, among other things, restoring and adjusting for final light intensities, as visible at the presentation (or memory) unit M.

### EXAMPLES OF EMBODIMENT & APPLICATIONS IN DETAIL

The present invention applies to an electrooptical instrument with capacity to eliminate some of the more fundamental restrictions which have always prevailed within photography. Most examples exemplifying the invention here aim at depth of field-improvements. However, other fundamental limitations may be remedied in an essentially similar or equivalent way.

It's an instrument with capacity to measure image definition, optically projecting a scene upon an electronic detector, registering images/frames in different states of focus, and all subdivided into smaller parts. That part-picture having best image definition is chosen and merged into a resultant final image, being saved in an electronic memory and/or being presented as a picture on paper or an image screen.

The invention, according to various configurations in the characteristic parts of relevant claims presented here, is thereby solving the problem to obtain high image definition for various focal distances, on one and the same image.

The most important design parameter for an image-registering instrument, may well be highest possible image resolution, i.e. to produce a sharp image over largest possible portions of the total field of view. However, strictly speaking, sharp images are only created for objects staying in an optical focus, while objects out of focus, within the field of view, remain more or less blurred, which may often be to disadvantage. For example a soldier using night vision goggles (Cf. Patent SE450671) may stumble against nearby branches, barb wire etc because he can only focus on one distance at a time and small nearby objects are thus wiped out, because the device is mostly focused further away due to other practical reasons. Another example may involve an automatic surveillance camera, where the task is to identify persons and objects at various distances at the same time but where only one focal distance at a time, is feasible. Even a still camera photographer may experience problems associated with various object distances, for example when attempting to take an indoor photo full of details, showing the distant wall as well as nearby objects, in high resolution. And the need to focus on two actors at the same time, happening to be at differing distances from the camera, is a problem from the film industry. A remedy for this last problem has been suggested (Cf. U.S. Pat. No. 4,741,605) as follows: A movie film camera lens aperture is divided into parts in such a way that two differently-focused but superposed images are created. However, consequently the two images in focus are also merged with two other images out of focus, thus halving the image contrast more or less. This method does furthermore only provide two focal distances while a normal field of view may be built up of objects with several more states of focus, some of them even rapidly changing/moving. The effective F-number of the instrument is also influenced by this technique.

The present invention does improve this situation inasmuch that many more focal distances can be used and unfocused/blurred image information is furthermore rejected so that the final image is mostly containing high definition and high contrast contributions.

Thus, an instrument according to the present invention, with capability to refocus continuously for all distances in-between infinity and closest range more or less, then register and sort the image information as described, should be able to produce high image definition all over the final image. Or in other words, an instrument according to the present invention is de facto producing images with infinite depth of field. ‘Depth of field’ is a commonly recognized measure for the distance interval, centred around an associated focal distance, within which a photo remains sharp. A short such ‘in depth’ distance is equivalent to poor depth of field, being degraded by working with high speed lenses (Low F-number) and large optical entrance apertures or long focal lengths in general, like telephoto lenses. The main object of the present invention, i.e. to improve the depth of field, is by no means a new thought: The traditional mode of improving optical instruments in this respect has been by decreasing objective lens diameters, like stopping down a camera lens, cf. above. However as a result, the lenses gather less light, implying other drawbacks like longer exposure times, giving associated motion blur and grainier film, and these effects degrade the definition of a final image. The objective lens diameter may even be reduced to the size of a needle point aperture of a so-called Camera Obscura, with the capacity to project images with alnost infinite depth of field, however unfortunately increasing the photographic exposure times to hours or days at the same time, making this method practically useless for most applications.

Another well-known remedy for depth of field problems, is to miniaturize the instrument, i.e. design for a shorter system-focal length, like when Leica introduced the new and still prevailing 35 mm minicameras. Another similar development has taken place more recently for those small digital cameras having only about 6×8 mm sensor-size and a normal focal length around 12 mm, thus just one quarter of the equivalent minicamera, where the frame size is 24×36 mm and focal length is around 50 mm. Even the image intensifier technique undergoes a similar development, with image/photocathode reductions from 25 mm or bigger in the 1960-70's to 18 mm during the 1980-90's and a further reduction to 12 or 16 millimetres today in USA and Europe (Cf. U.S. Pat. No. 6,025,957). This miniaturizing gives an improved depth of field in general, however at a cost of reducing the number of image points/pixels being resolved across an image area. This development was nevertheless made possible by an equivalent improvement of image resolution and light sensitivity of the registering components involved (like CCD sensors, Image Intensifier Tubes and Photographic film). These above-mentioned methods offer some relief but the depth of field problem is still there. One professional category only, namely the landscape-painters, have from time immemorial been able to master these problems, by using the oldest known optical device (the eye): Sometimes painting the nearby foreground, sometimes the background but reproducing each little object by itself, thus assembling a whole painting from a great many differently-focused image parts. The later observer may therefore (apart from some more artistic qualities) appreciate the ‘infinite depth of field’ of the old paintings: A painting is watched from a certain distance, even though real objects from widely varying ranges are reproduced. This artistic way of metamorphosing a scene, with entirely different (optimal) states of focus, into a flat and everywhere sharp reproduction and with one state of focus only, has certain features in common with the present invention.

The above-mentioned depth of field-problems can be eliminated or at least reduced by utilizing some characteristic features related to the present invention, following the introductory passage and exemplified below by an electrooptical instrument like a video camera, a digital still camera, an image intensifier instrument or a surveillance camera (i.e. ‘Instrument’ for short):

1. The instrument is provided with an automatic focusing device (1) so that the objective lens (2) may be focused on more than one object distance.

2. The initial image B1 is focused on a suitable distance, like ‘infinity’.

3. The same image is registered by the detector (3), thereafter transferred to an image memory (4).

4. There is an image-part-function (5) associated with the image memory which subdivides the same whole image into smaller sub-image segments B1i, B1(i+1), B1(i+2) . . . thus making it possible to address these image parts, making them individually accessible from the detector and/or image memory.

5. The instrument is next focused for another and usually pre-determined object distance and a more recent image frame B2 is registered by the detector.

6. The Instrument is also incorporating an image-definition meter (6) with capacity to assess the image resolution of each little sub-image individually.

7. This image definition-detector is associated with a comparison-function (7), enabling comparison of image resolution for each sub-image couple, i.e. B1i with B2i.

8. Initial image-part information B1i is replaced by corresponding subsequent sub-image information from B2i in case image definition of B2i is estimated to be superior to B1i;

or alternatively, later image information of B2i is discarded while previous information from B1i is retained without alteration of memory, if the opposite situation occurs, i.e. the sub-image B2i appears to be less in focus than B1i. This selection procedure is repeated for all image parts 1,2,3 . . . i.

9. The Instrument is thereafter refocused again, more pictures B3, B4 . . . Bn being registered in the process and the same procedure (#5-9) is repeated.

10. The resultant image (i.e. at least as far as depth of field-enhancement procedures of this invention goes) is finally in memory, when the last focusing step has been finished.

The simplest design of this ‘Instrument’ involves an objective lens (2), however other optical system-components like teleconverters, eyepieces, scanning- or (image) relay-systems may be included for certain applications, making the total system more complex. Automatic focusing devices (1), (not to be confused with the well-known ‘Autofocus’, see below), can be set up in many different ways: Like in time-sequence, so that different focuses appear in succession. However a static mode, for example by means of beamsplitters, is also feasible, involving several active and differently-focused image planes at one and the same time. There are detectors (3) of various kinds, but the so called CCD chip, made up of a two-dimensional matrix of pixel-sensors, is most frequently occurring in video- and digital still cameras. There are also infrared (IR; like pyroelectric) sensors, vidicon- and image-intensifier tubes. The detectors may also be singular or linear detector arrays. Image memory (4) is here a wide concept covering electronic computer memories associated with the instrument, magnetic tapes, RAMs, hard- or floppy disks plus CD or DVD disks and ‘memory cards’, commonly delivered these days with digital cameras: This latter kind is constituting a final memory for an Instrument, like would also (sort of) be the case for an image printing process, where digital information may cease, image information nevertheless surviving on the photographic paper. And associated with this are presentations on image screens for TVs and computers and other image viewers or screens which only retain an image as long as the presentation lasts. It may prove advantageous for some applications to use several memories, like for the image process inside an instrument plus a final memory where only processed images are stored. The pictures Bn are subdivided (5) into image segments or sub-images Bni, each of them (if applicable, see below) big enough for some contrast measurement, however still small enough for ensuring continuity and uniform image definition across the final picture: The instrument must therefore incorporate an image definition-meter/analyser (6) to bring this about, like a passive contrast measurement device of the kind prevailing in video- and still cameras since long ago. The first introduction of such a camera on the market was possibly by the manufacturer Konica with its ‘Konica C35AF’ camera (Cf. an article in the periodical FOTO 1/78), incorporating an electronic range-fmder, founded upon the principle that maximum image contrast and resolution occur simultaneously more or less. The focal distance for a small picture area in the central field of view was thus measured with this camera through a separate viewfinder, identifying a state of focus with optimal image contrast, thus approximately answering to the best resolution, whereupon the lens of the Konica camera was automatically refocused accordingly. This is the common method even today more or less, cf. for example the Olympus digital still camera C-300ZOOM, having a somewhat similar autofocus device according to its manual.

There is an important distinction though, as regards how this contrast measurement technique is utilized, according to the present invention: While the above-mentioned commercially available consumer cameras are adjusting for a best focus using this technique, the very opposite takes place for instruments, according to the present invention: Instead a sequence of images with pre-defined states of focus are exposed and the contrast measurement technique is applied afterwards in order to select (7) the sharpest sub-images. And there is another fundamental difference: Contrast measurements, according to the present invention, take place all over the image/field of view, while Autofocus cameras according to present day technique, are mostly measuring inside a small image-segment only. It may thus be asserted that an instrument, incorporating the present invention, may well use elements of prior art, but in an entirely new context. Explicit range measurements are not necessitated by this technique, however it's feasible to assess average distances for each image segment because optimal states of focus and thus (in principle) the appropriate focal distances are known by means of this contrast measurement approach. The introduction of a distance measurement function of this sort provides the basis for continuous mapping of projected scenes in three dimensions, because the information of each sub-image segment (Co-ordinates X and Y) is now associated with a distance Z (Co-ordinate in depth). It would therefore be possible to transfer this image and distance information to a computer, the object for example being to produce three-dimensional design documentation for the scene depicted, thus the basis for applications like 3D presentation, animation etc. A small video camera can be moved inside reduced-scale models of estate areas, within human vascular systems, or inside the cavities of machinery, sewage systems or scenes which are to be animated for film or computer game purposes, not to mention industrial robots requiring information about all three dimensions when manoeuvering its arms: All these applications mentioned may, as a consequence of the present invention, benefit from the continued supply of three-dimensional information, related to each image part of the scene.

As a matter of principle, it's possible to carry out the distance- or image definition measurements on one occasion only, for a stationary instrument, i.e. same aiming all the time, involving a static scenery more or less. This application is explicitly exemplified by installation of a stationary surveillance camera as follows: The camera undergoes the above-mentioned process #1-10 during installation and this is possibly repeated after each fresh start up. It's preferably done very precisely, by means of many nearby states of focus, the whole procedure being repeated a number of times so that an average of many cycles #1-10 may be estimated, the optimal focus of each image part thus being assessed more precisely than would otherwise be the case.

The camera may henceforth be operated without necessarily using image definition-measurements, because the fixed and essentially stationary scene ranges are already known, the most optimal states of focus for each image part thus remaining the same more or less, being saved in a memory. Temporary and stochastic disturbances, like waves on a sea or swaying trees at the horizon, may furthermore influence wide areas of a fixed scene during stormy days, thus affecting the image definition meter. A better solution would be to save this above-mentioned range-finding procedure for some calm and clear day without that multitude of fast flutter.

A frequent and major task for surveillance cameras is to detect and observe new objects, figures etc emerging on an otherwise static scene. Such objects may or may not emerge at the same, static/initial object distance from the camera, thus appearing more or less blurred, depending upon current depth of field and other parameters, in case the image defnition-detector was switched off. However turning this meter on again, it would be possible to detect new objects within the field of view by comparing the initially assessed states of focus for each sub-image, with any more recent such measurement, thus enabling detection of changes within the field of view, i.e. for each specific sub-image segment, causing the alarm to go (blinking screens, alarm bells etc).

The function of an image definition-meter may involve some algorithm for the assessment of image contrast (Cf. U.S. Pat. Nos. 4,078,171 and 4,078,172 assigned by Honneywell) within a small sub-image. Let's suppose this is done with n detector elements, uniformly distributed over the sub-image. At least two such detector elements are necessary for the contrast measurement: Suppose an (image) focus-edge is crossing this segment: A bright sunlit house wall (with intensity Lmax) being (for example) registered by detector D1 on one side and a uniform but dark background (intensity Imin) like thunderclouds at the horizon, being registered by detector D2 on the other side. The contrast may then be written as

Cmax=(Lmax−Lmin)/(Lmax+Lmin)

according to elementary theory. There would ideally be these two light levels only, as long as the house wall is in focus, i.e. the edge is sharp. However the edge becomes increasingly blurred if defocusing the instrument, i.e. light intensity will then gradually (depending upon the distance in-between the two detectors) change from Lmax to Lmin when passing a transition zone in-between house and background. The intensity measured by detector D1 will thus decrease from Lmax to L1 while detector D2 is registering a light intensity increase from Lmin to L2. The difference L1−L2 and as a consequence the contrast C=(L1−L2)/(L1+L2) are thus diminishing.

And it's vice versa possible to identify and correct for such image intensity gradients of a picture by means of electronic image-processing programs, compressing the transition from a bright to a dark zone, so that the gradient is increasing, the border in-between darkness and light becoming narrower and the image consequently getting sharper.

An image definition and analysis function associated with the present invention, should ideally choose that state of focus corresponding to the close house wall of the above-mentioned and much simplified case, thus giving a sharpest possible edge against the dark background. However a significant further contrast structure of the background would complicate matters, creating another optimal focus within the sub-image segment. A generalized contrast algorithm involving more than two detector elements would then be required. A further development of this method is to replace above-mentioned step #8 with an alternative and expanded procedure, where image definition and information, registered and measured for each image part and for each state of focus during a focusing-cycle are saved, and this would make it feasible to choose and perform some kind of weighted fusion of image information, related to several optimal states of image resolution. The statistical weight of a corresponding major maximum might even be chosen as zero, like for the feasible case of a surveillance camera being directed through a nearby obscuring fence. A new distance-discriminatory function would be appropriate for such cases, i.e. a device blocking out image parts with optimal focus closer than a certain proximity distance, like the above-mentioned fence. Another example: The Instrument may be focused for two optimal states (other focusing distances being blocked out) for every second final image respectively, being produced.

A typical case would be a nearby thin and partly transparent hedge, through which a remote background is visible.

It's obvious that a comprehensive catalogue of all applications implicated by the present invention, can't be presented here. It's emphasized though that characteristic features of the invention, according to the claims enclosed, are of general validity and the exemplary embodiments shall not limit this scope.

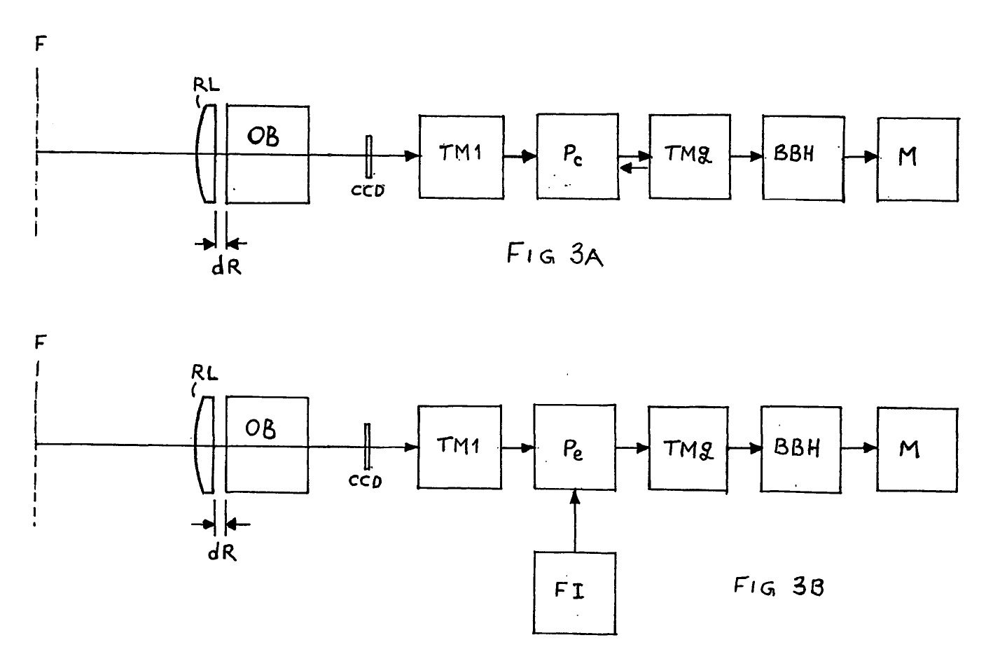

Another and essentially different image definition measurement method is involving actual distance measurements with for example a laser range-finder: This is an active method, similar to radar, involving a laser pulse transmitted, then reflected against a target, finally returning to the detector of the laser range-finder receiver. The distance is calculated from the time measured for the pulse to travel forth and back. This procedure must, according to the present invention, be repeated for the individual sub-images and one way to bring this about is to let the transmitting lobe of the laser range-finder scan the image vertically and horizontally, somewhat similar methods for instance being employed already in military guidance systems. The laser range-finder transmitter and receiver can be separate units or integrated with the rest of the optics and structure of the instrument. For example, it would be possible to design an image detector (3), where each little segment (besides registering the image), is incorporating a laser detection-function, thus integrating the range-finder receiver with the image recording parts of the optics, related to the present invention. The distance to, and as a result, optimal state of focus for each image part may thus be assessed because focal distances related to pre-determined states of focus are known, in principle. No explicit measurement of image definition is thus required here (cf. FIG. 3b). The distance information does nevertheless point out those differently-focused image-parts, which are offering optimal image definition.

The object of bringing forward these techniques, i.e. how to assess optimal states of focus for sub-images within a scene, is to demonstrate the wide-ranging feasibility of the present invention, rather than restricting its scope.

Only part of the image processing required has so far been covered by this text. Further steps may prove essential for a more satisfactory outcome of the operation: It's an important design target that the instrument is capable of producing uniform pictures without visible discontinuities. Choice of sub-image size may turn out crucial, it's for example important to make them small enough in order to secure optimal continuity in-between adjacent sub-images as regards state of focus. On the other hand, sub-images must be made big enough in order to resolve image structures, like contrast variations, with enough precision with reference to the above-mentioned contrast measurements. Spatial smoothing of adjacent image segments, is another well-known technique, cf. for example existing Adobe Photoshop commercial (PC) programs. This procedure may improve image-uniformity, however at the same time tending to degrade the contrast of minor image details. Image compression techniques like *.jpg may also be incorporated but this is not the proper forum for repeating facts about well-known techniques.

A novelty though, related to the present invention, is that averaging of image information may be expanded from the ‘normal’ X/Y image plane to the third in depth dimension Z, involving adjacent states of focus for one and the same image segment, this however requiring adequate storage memory for such running image information.

Another phenomen to be considered, is variation of picture size in the process of refocusing, like distortion (i.e. magnification variations). However an electronic remedy for this is possible, like keeping sub-image sizes unaltered, irrespectively of actual state of focus.

An essential aspect of the invention is thus that the instrument can be appropriately refocused, a subsequent choice in-between different states of focus thereafter taking place.

The modus operandum may be static by means of partition into several image planes, but more generally dynamic by following an automatic pre-defined time-sequence schedule, and there is a multitude of different ways to bring this about:

One common method to focus a camera is for instance to move one or several objective lens-components, usually at the front, along the optical axis. A single continuous refocus-movement from infinity to—say—the proximity distance of a meter, can be executed in this way. This refocusing-process may thus take place continuously rather than in discrete steps which may prove advantageous at times. However, these mobile lenses must stop at the ends, the motion thereafter becoming reversed, which may prove impractical at high speeds, and where many focusing-cycles per second is an object. The method will nevertheless suffice where refocus-frequency is low, like for certain digital still photo cameras.

Another method would be to introduce one or several glass-plates of different thickness, usually in-between exit lens and image plane. Such glass plates are extending the optical pathway, moving the image plane firther away from the lens. Several such plates of various thickness, placed on a revolving wheel with its rotation axis differing, albeit in parallel with the optical axis, may be arranged so that each of the plates is, one by one and in fast succession, transmitting the rays within the optical path, as the wheel rotates: This is a very fast, precise and periodic refocus-procedure and it would be possible to rotate a small lightweight low friction-wheel with a uniform, yet high speed of at least—say—1000 turns per minute. This mode would therefore approach TV application speeds more or less, with 25 pictures per second (PAL). Each picture should be registered and processed for the different states of focus, i.e. ideally 5×25=125 pictures per second here, with 5 different states of focus (like infinity, 10, 5, 3 and 2 meter focal range). However, a trade off involving rotation speed reduction and several TV frames, associated with one focusing-cycle only, seems feasible, though possibly causing side-effects as the differences in-between consecutive TV frames mount up, and for fast moving objects.

The fastest method however, should be to equip the instrument with several differently-focused image-detectors. It's for example an established digital video camera technique to use 3 CCD-sensors (like the Sony DCR-TRV900E PAL camera; The purpose in this case being different however, namely to register the three main colours (RGB) with separate sensors). There are several ways to implement this in practice like inserting suitable beamsplitters, usually close to the image plane behind the objective lens. A split into two or several spatially separated images can be arranged by such means and each of these pictures can be registered with for example CCD-sensors. Beamsplitters are in common use and may be made of dichroic or metal-coated mirrors or prisms in various configurations and with differing spectral and intensity characteristics depending upon requirements for specific applications. The advantage of this procedure with reference to the present invention, is that it gives simultaneous access to a sequence of pictures, only differing about state of focus. The comparison procedure may thus be undertaken with pictures having been registered at the same time and all time-lag influence caused by successive refocusing is avoided. The method is apparently only feasible for a few, like three, detectors, i.e. states of focus, which may hamper certain applications. Refocusing-cycles with many steps of focus may reduce the effective speed of an instrument, or prolong the exposure procedure: Assuming the total time for such a cycle to be=t and the number of steps/frames to be=n, then the effective exposure time, i.e. time available for registering each state of focus, becomes=t/n. A total exposure time, associated with the final image, must therefore (exposure conditions being the same) become n times longer than for the single exposure of a standard still camera of today (i.e. this invention not being applied). The consequences may well be negligible though, or comparable to those time-lags introduced already by autofocus and flashlight functions. Fast objects may move a little in-between successive exposures however, motion blur is essentially originating from single frames, because only one state of focus is relevant for focusing upon the majority of objects.

Three modes of focusing have been described so far. They are representative but there are many other ways to bring it about, exemplified in brief as follows:

The detector may be focused by axial translations, being small most of the time like tenths of a millimetre, but still an oscillation forth and back which may be impractical for fast sequences, at times. A most interesting concept would be a three-dimensional detector with capacity to detect several differently-focused ‘in depth’ surfaces at the same time. Thus no mechanical movements nor beamsplitters necessary here whatsoever, though the costs may be of some consequence.

The above-mentioned wheel can be replaced by some rotating optical wedge giving continuous refocusing but introducing optical aberrations at the same time: It may be acceptable though, or at least possible to correct.

A multiplicity of technical solutions aiming at refocusing-procedures necessitated by the invention are thus available. The principles of the invention are of course not restricted by these particular examples.

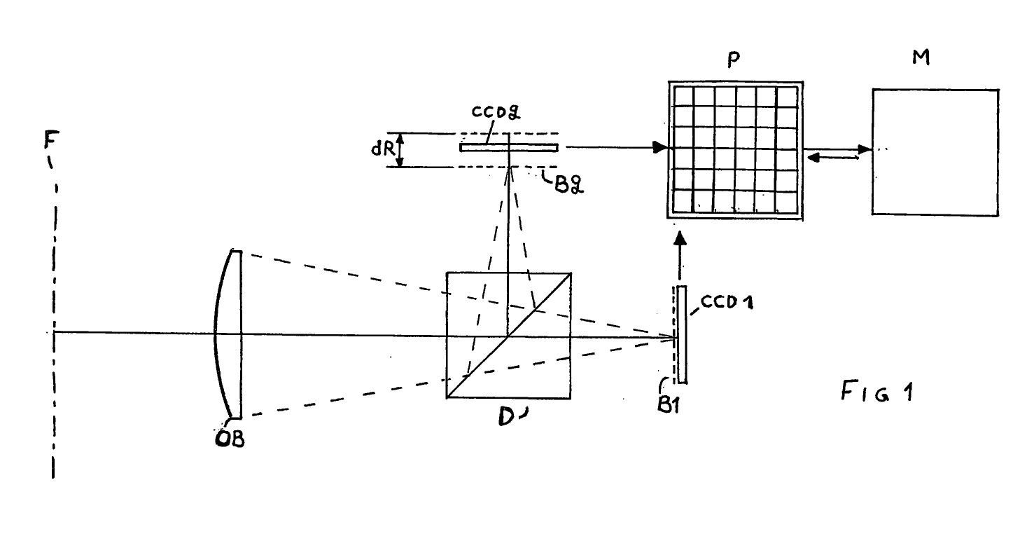

A particularly simple application example (FIG. 1) of the present invention, shall now be described, where memory capacity requirements and mechanical movements are minimal. The objective lens is projecting an image of the field of view F on two image planes B1 and B2. This split is done by a beamsplitter D, dividing the wave-front into two different parts with equal intensity. The image plane B1 is here stationary and the image is detected by the CCD-sensor CCD1 while the mobile image-plane B2, corresponding to various states of focus, can be detected with another sensor CCD2, which is subject to axial movements. This adjustment=dR may be effected by turning a knob on the outside of the camera, corresponding to refocusing the instrument from infinity to—say—the proximity distance of a meter. The two detectors are connected to an electronic processing unit P, with the following functions:

| | |
|---|---|
| 1. | Images B1 and B2 are subdivided into smell image parts B1i and B2i |
| | by electronic means. |
| 2. | Image contrast (sharpness) for each image couple B1i respectively |
| | B2i is calculated |
| 3. | These contrast values are compared, i.e. for each couple. |
| 4. | Sub-image information associated with that image part (from a |
| | couple) having superior image definition, is forwarded to image |
| | memory M (Information from the other image part being rejected) |

This procedure is repeated over and over again, for all sub-image couples B1i/B2i, B1i+1/B2i+1 . . . until a resultant fmal image has been saved in image memory M, which could be a so called memory-card, detachable from the camera after finishing photography: Such cards are nowadays widespread for digital still camera use. Some further image processing like *.jpg compression, distortion-correction and edge smoothing in-between adjacent image segments or sub-images (cf. above) may also take place in a more realistic scenario, where additional memory capacity may prove advantageous or even necessary (cf. FIG. 1) for intermediate storage of image information while the process is going on in the processing unit P, cf. FIG. 3. Image elements from two different states of focus only, are thus contributing to this particular final image, however the associated depth of field-improvement is still significant: Suppose the focal length of an objective camera lens OB is around 12 millimetres, other parameters like F-number and ambient light condition being reasonably set. The depth of field could then well be from infinity down to something like 5 meters for sensor CCD1 where the focal distance is—say—10 meters. Let's furthermore suppose that the second CCD2 sensor-focus is set at 3 meters, creating a depth of field from—say—5 meters down to 2 meters. The total, using both detectors, would then be to create an accumulated depth of field in-between infinity and 2 meters, as manifested on merged and final images, viz. after having applied the methods of the present invention. This is of course much closer than the five meters, however it's only one of numerous hypothetic examples.

A stunningly fast development of digital still camera performance is presently taking place, which will thenceforth accentuate focusing and depth of field-issues. The Olympus-camera CAMEDIA E-10 with 4 million image-pixels and flexible image processing may represent a ‘State of the Art’ (i.e. in A.D. 2000).

It's also possible to move the image process, associated with the present invention, to a separate computer (PC) station. The processing of differently-focused image sequences from one and the same scene, moreover registered with some standard camera without processing-refinements prompted by this invention, may take place there. No electrooptical instrument, like a digital camera, is necessarily required for this mode of operation. A traditional emulsion-film camera will do, image digitizing possibly taking place in a scanner, after the film has been developed, subsequently forwarding the frames to the computer. This may for instance be done in the processing laboratory engaged, ensuring that depth of field-enhanced photos are delivered to customers, who don't even have to think about it! Basic principles of the invention remain the same nevertheless, i.e. frames must still be converted for a digital/electronic medium in order to have them processed. However two main ingredients of the invention, i.e. a focus-scan followed by some digital processing, are here separated, the latter taking place independently and somewhere outside the camera proper. Instruments associated with the present invention, are thereby physically generalized now involving more than one locality like (in this specific case) a still camera and a PC computer with requisite program software.

As a contrast, the already described stationary video surveillance camera provides a more complex system and what is more, may incorporate image intensifiers (i.e. nightvision capacity) and telephoto lenses. Crucial lack of light and poor depth of field in association with large apertures (small F-number) and long focal lengths, may here arise. It's possible to increase the memory capacity of the system, enabling storage of image information and focusing data from frames belonging to several focusing cycles. Processing and selection of image information may then be more independent of focusing cycles, allowing introduction of delay and a certain time-lag in the system before the processed images are presented on an image screen or are saved on magnetic tape or DVD disk. Image processing may even take place much later in another context and somewhere else, using for instance magnetic tapes with primary information available. This is similar to the still camera example (above) where the basic function was split into two or several spatially separated embodiments: The Image registration involving refocusing-cycles is thus accomplished by a surveillance camera in situ while the image process may take place miles away in a computer. This procedure allows for the use of more powerful computers, a possible advantage where huge volumes of information are to be handled.

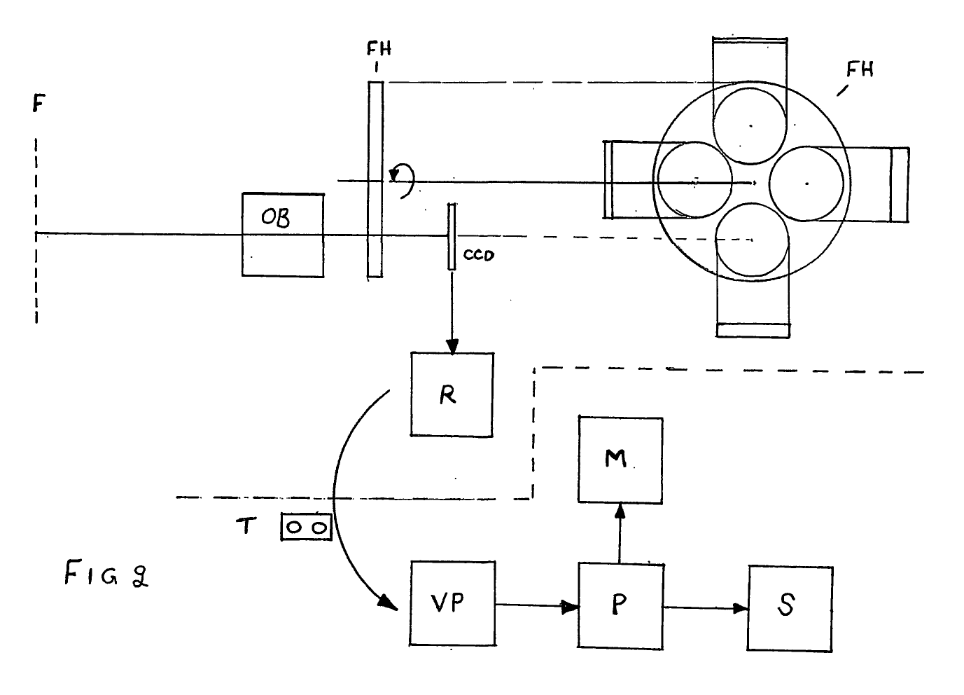

This application shall now be described in more detail (FIG. 2): The surveillance camera is installed at locality A, where the scene F is projected by objective lens OB onto an image plane where a CCD-sensor belonging to a video camera is detecting the image. A focal fluctuation in-between four different states, is executed with the focus-wheel FH incorporating four flat glass-plates of different thickness: It's a fast revolving wheel giving four different focuses per turn. Video frames are registered on the magnetic tape/video cassette T at recording-station R. This video tape T is then transported to another locality B somewhere else, where the tape T is again played on another video machine VP forwarding image information to a processing unit P, which is selecting that better-defined image information in focus, already described (above). The processor P is therefore, in this specific case, selecting information in focus from image groups of four. The processed video film is finally stored in memory M or presented on image screen S. A more qualified use, under poor light conditions in particular, may involve the record and presentation of raw unprocessed images as well as depth of field-enhanced images, following the principles of the present invention. Optimal focusing-data may moreover be stored for respective image-parts, thus avoiding to make contrast-measurements all the time, this being particularly expedient when such measurements tend to be ineffective or even impracticable to undertake, like whenever light conditions are poor. Other functions belonging to this kind of somewhat sophisticated systems, may include an option to vary the number of sub-images employed or the number of differently focused frames during a cycle, the object being to reach optimality for various ambient conditions.

Certain aspects of the present invention are further illuminated and exemplified in FIG. 3a as follows: A view F is projected by objective lens OB onto a CCD-sensor. This lens OB has a mobile lens component RL, adjustable (dR) along the optical axis, equivalent to refocusing from infinity down to close range. The lens RL is moving forth and back in-between these end stops, passing certain focusing positions where exposure of pictures take place in the process. Image information from such an exposure is registered by the sensor, then forwarded to a temporary image memory TM1. The processing unit Pc is capable of addressing different sub-images and to receive selective sub-image information from TM1 and similarly from the other temporary memory TM2, the latter containing optimal image information, previously selected during the focusing-cycle going on. Image contrasts are calculated and then compared for the two states and that alternative giving highest contrast is kept in memory TM2. Even more information may be saved in memories like TM3 (not shown), speeding up the procedure further whenever, as a consequence, certain calculations (of contrast for example), do not have to be repeated over and over again. Further image processing, where the object is to improve upon image-quality and possibly compress the image, will then take place in unit BBH and the resultant image is ending up in final memory M.

The situation in FIG. 3b is similar except for one important thing: The processing unit Pe is no longer calculating image resolution nor contrast. Instead the processor gets its relevant information about optimal states of focus for different sub-images from other sources, i.e. memory unit FI. This information may originate from a laser range-finder or be range information earlier assessed from a stationary installation (cf. above). Such information suffice for the processing unit Pe when selecting image information for each state of focus, giving sharpest possible image. This select information is finally transferred to the temporary memory TM2, the rest of the procedure following FIG. 3a (above). Various possible set-ups and applications related to the present invention and its depth of field-improvement functions have now been proposed. It would be possible to describe numerous other such explicit versions having the following features in common:

| | |
|---|---|
| 1. | It's an electrooptical instrument, in the sense that original pictures are |
| | projected by an optical device while electronic digitizing and image |
| | processing associated, is taking take place in the same physical |
| | embodiment or somewhere else. |
| 2. | This same electrooptical instrument, i.e. described by claims and text |
| | associated with the present invention, can distinguish and detect |
| | individual sub-images or segments of a whole image. |
| 3. | The image may be refocused in various suitable time-sequences. Or |
| | as an alternative, the instrument is capable to register more than one |
| | differently-focused image simultaneously. |
| 4. | The instrument may select that state of focus corresponding to a |
| | certain set of (similar) sub-images, giving optimal image definition. |
| 5. | Image information from the most optimally focused frames, belong- |
| | ing to each individual sub-image set, is added to a final compound |
| | image being effectively assembled from differently-focused image |
| | parts more or less. |
| 6. | The resultant image is saved in an appropriate final memory and/or is |
| | presented on an image screen or similar. |

### Image Processing

The image information required is, according to the present invention, extracted and assembled from original exposures, depicting the same scene, but with different settings. The object is to produce an improved final image of select image information and this can be achieved in several different ways, described as follows and commencing with methods related to improvements of depth of field.

1. Average-methods

The mode of superposing differently-focused images is conceptually simple. It may be accomplished as follows:

1. Optically in an objective lens system or a binocular, by means of dividing the aperture in portions of different refractive power (cf. U.S. Pat. No. 4,741,605 by Alfredson et al)

2. By means of a wave-front division in part reflective mirrors, thus generating at least two ray paths, which are spatially separated and differently-focused, however finally reunited into a composite image, made up from differently-focused contributions.

3. By refocusing an objective lens, belonging to an instrument for image registration, this being so quickly executed, that several states of focus occur during the exposure time.

4. Periodic refocusing, faster than the physiological reaction time for the eye (around 1/10 of a second) in visual instruments like optical viewfinders or telescopes, so that the observer is unable to perceive individual images, this being rather much like watching a movie.

5. By double exposure of a ‘classic’ emulsion-film camera and

6. Electronically by means of some superposition or pixel by pixel summation of differently-focused electronic images.

The feature in common for these average-methods is some summation of all available image information, thus including the out of focus contributions as well, however thereby degrading image contrast and quality in the process. Such images are here denominated ‘average images’ (M), with the corresponding ‘average-method’ for short. (Reference: Program software for PC computers for the purpose of superposing electronic images exist, cf. ‘Image Fusion Toolbox’ for ‘matlab 5.x.’, now freely downloaded from Internet address www.rockinger.purespace.de/toolbox_r.htm; Cf. also reference to a ‘linear superposition’ average-method corresponding to #6 above, on the web address of same Oliver Rockinger, and his thesis ‘Multiresolution-Verfahren zur Fusion dynamischer Bildfolgen’, Technische Universität Berlin 1999, for a more general account of image fusion methods. The digital camera ‘Finepix S1Pro’, produced by Fuji Photo Film Co Ltd in Tokyo Japan, allows superposition of sequentially exposed images).

2. Contrast-enhanced Average Methods

A further developed and improved method, related to electronically registered images, is involving an additional procedure of subtracting or removing the above-mentioned out of focus image-information. The result may generally be described as a concentration of ‘focused image information’ in the final picture or in other words, out of focus-image information is discarded. This process may be more or less efficient, depending upon model approximations. A version denominated ‘contrast-enhanced average method’ will be exemplified as follows:

The above-mentioned average image (M) is defocused, its intensity thereafter being reduced by a suitable factor and this picture finally being subtracted from the compound average image (M). This last procedure implies a defacto reduction of noise from the average image (M), this being the purpose. The above-mentioned defocusing may be performed electronically, such ‘blur-functions’ generally exist in commercially available image processing programs (like the ‘Photoshop’ PC programs from Adobe Systems Inc, USA). A 2-image process may thus symbolically, and in a very simplified way, be written as follows: The proximity-focused image A consists of portions which are focused A(f) or unfocused A(b). The remotely-focused image B is similarly consisting of focused B(f) or unfocused B(b) parts:

A=A(f)+A(b) (1a)

B=B(f)+B(b) (1b)

The ‘averaged’ picture M is now created.:

M=A+B=A(f)+A(b)+B(f)+B(b) (2)

The defocused average image M(b) is next created:

M(b)=A(f)(b)+A(b)(b)+B(f)(b)+B(b)(b) (3)

where (b) represents defocusing/blurring and (f) stands for focusing in accordance with what was written above. The following relationship applies more or less like a definition, to the transition from the state of optimal focus to a state of blur

A(f)(b)=A(b) (4a)

B(f)(b)=B(b) (4b)

The assumption that image information defocused twice is yielding the same result as if defocused once only, is an approximation. However we are nevertheless writing:

A(b)(b)=A(b) (5a)

B(b)(b)=B(b) (5b)

(4) and (5) are now substituted into (3), giving

M(b)=2A(b)+2B(b) (6)

and the intensity of this image (6) is finally halved and subtracted from the average picture (2), giving us the resultant picture R:

R=A(f)+A(b)+B(f)+B(b)−M(b)/2=A(f)+B(f) (7)

This final image (7) may now be compared to the average picture (2) above: The unfocused image information A(b) and B(b), from original pictures, has apparently disappeared, while the focused image information is retained. Or in other words: Using this method, the image contrast has been enhanced by rejecting image-components which are out of focus, the in-focus information being retained however. As already mentioned, these relationships reflect an approximate model for defocusing: Picture regions are rarely completely in focus or out of focus, rather something in-between. The discussion is nevertheless indicating a distinct possibility to cut down unfocused image components, from average images. These further processed images are henceforth called ‘contrast-improved average images’. The discussion (above) involves only two differently-focused images, however the discussion is valid for any number of pictures, not shown here due to triviality. These methods producing contrast-enhanced average pictures may be used for viewfinder applications, when making template pictures (described elsewhere in this text), for certain video camera- and such still photo camera applications, where the resultant image is deemed ‘good enough’ for its purpose, this latter property not always being the case however.

3. Filter-methods

Each of the original pictures are, according to another method developed, filtered by means of laplacian or fourier operators (Cf. also the so-called Burt pyramid, U.S. Pat. No. 5,325,449 to Burt et al. and U.S. Pat. No. 4,661,986 to Adelson and U.S. Pat. No. 6,201,899 to Bergen) whereby a series of transform-pictures are created. This filtering is executed row by row (filtering of video- and related signals), as far as these descriptions ca n be interpreted. Transform-images do generally consist of image-series (like L0, L1, L2, L3 . . . Li), containing, so to speak, all available image information as a whole, but where usually each individual transform image (like L0) is holding only part of the total information. The character of these transform-images is entirely different from the original pictures and may therefore not be merged into a final image with improved depth of field. However their intensity-distributions may nevertheless reveal such parts of a picture, which are more in focus or (more appropriately expressed as far as lower order analysis goes), where the largest concentration of outlines or edges in focus are located. It's possible to map the high-intensity distribution of a transform-image (thus higher contents of focused image information), called sub-regions. Intensity distributions of such sub-regions on filtered images, up to a certain order (however usually restricted to lowest order(s), because of practical reasons ) are compared, enabling a selection of the corresponding regions—from the differently-focused, original pictures. Sub-regions of higher intensity, from the differently-focused and filtered images are thus identified by using this technique, and the identification serves (as far as filtered-image intensity and optimal focus correspond to each other) the purpose of pointing out the associated sub-regions on original exposures, for a final image synthesis, with depth of field-improvements. This method may require respectable computing capacity, in case all transform images up to a certain order (i) are to be processed. There are 4 times more pictures to process with the transform pictures L0, L1, L2 and L3 than if only a single picture L0 is to be used. This is a reason why the laplace-filtering process is so often restricted to lower order analysis only, consequently (as far as the selection process goes) only utilizing a limited part of the total image information, from original photos. It's previously known that laplace-filtering, of this kind, is suitable for identification and reproduction of edges and patterns, a frequently desirable property when working with microscopes.

4. Segmental Methods (SM)

Original pictures are electronically subdivided into sub-images or segments according to an aspect of the present invention, this being another further development. These pre-selected portions of the image are analysed as regards image resolution or other parameters. A choice of image parts or segments having superior image definition, from respective original images, may thereafter take place. These select segments are merged into a final image. The name ‘Segmental Method’ (SM) will apply here to this technique. It differs conspicuously from other techniques in that the segments are distributed all over the original pictures, before the main image processing starts. There is furthermore no need for filtering of original pictures and finally, as a result, the total image information is utilized when choosing the segments. These segments (i.e. sub-images) are also the same or similar and evenly distributed over the picture areas, according to a preferred mode of operation.

This method is therefore particularly suitable for the art of photography, where depth of field-improvements are aimed at, where a primary object of the photographer is to reproduce a scene as faithfully as possible. On the other hand, the purpose is not to enhance/extract certain details, like edges, contours or patterns. Similarities rather than structures or patterns are therefore searched for in a preferred mode of operation, see below. It may furthermore be pointed out that segmental methods are also distinctly applicable to other selection criteria than image resolution.

It may prove advantageous, during ongoing image processing, to change shape, size, position, or combinations of these, for at least some of the segments subdivided, cf. also part #5 below for one of several possibilities, plus some relevant comments in part #10.

To sum up, the original pictures are divided into sub-images (segments), which are compared and a subsequent selection from these image parts is then performed, according to applicable claims and descriptions of the present invention. These segments, selected from original images recorded, are merged into a resultant image with better depth of field-properties than each individual and original picture by itself. This can be done in many different ways, a representative selection of them appearing below:

4a. Contrast Methods

This technique, belonging to prior art, is utilized when adjusting for some advantageous focal distance, when taking single photos. The measurement may then be performed within a few picture areas, providing some further optimization. (For further references, see the periodical FOTO #1 1978 and U.S. Pat. No. 4,078,171 or 4,078,172). Segments with highest available image definition, may be identified, using this contrast measurement technique: The image contrast is generally increasing, as the image resolution improves. The contrasts of different sub-images are thus measured and compared, according to an aspect of the present invention. Those sub-images showing higher contrast and therefore—in general—have higher image resolution, are selected. All such segments, i.e. qualified according to this criterion, are thus selected to be part of the depth of field-improved fmal picture. This is consequently one of several selection methods, however already dealt with in this text and since this measurement technique is already documented in other patents, it's not to be repeated here. Subheading for this segmental method, is the ‘contrast method’.

4b. The Template Method

The ‘Template method’ is a name coined for another comparative segmental technique, with the following characteristics: A differently produced, depth of field-improved photo (template), is first created for the purpose of comparison. This ‘other’ technique might be some averaging method, possibly contrast-enhanced, or any other segmental technique like the above-mentioned contrast method, and there are still many other ways to bring it about. The important thing is not how the template picture was produced, but rather that it's adequate for a comparative procedure viz. towards the original photo recordings. The template picture is—again—subdivided into sub-images, same as for the original exposures. Corresponding sub-images from original exposures are now compared with associated sub-images from the template picture and that original sub-image snowmg greatest similarity with the ‘same’ template sub-image, is selected for the final assembly of a resultant and depth of field-improved picture. The ‘similarity’ can be estimated/calculated in many different ways. However, some kind of comparative score is generally set up, involving pixel values from original-photo sub-images, being compared to corresponding pixel values from the template: For example by using a suitable algorithm, subtracting corresponding pixel values of an original photo and the template from each other, thereafter calculating some power for these figures, finally adding or averaging these contributions to some kind of score for the whole segment. There is thus more similarity, when the accumulated difference (score) attains a low value. The present invention is of course not restricted to these particular examples. Distinctive features of the template method, as compared to other methods, may be summarized as below:

| | |
|---|---|
| 1. | A field of depth-improved template picture is produced by other |
| | means, for the purpose of comparison. |
| 2. | Original photo-segments are not compared to each other but are |
| | compared to segments from the template picture instead. |
| 3. | Greatest similarity in-between picture parts from the original and |
| | template photos are identified by means of comparison. |
| 4. | The Template method does not identify any segments with maximum |
| | contrast nor image definition as such. |

There is of course no requirement for the template picture to qualify as a final result—this would in fact make the comparative template method superfluous. However the template pictures must nevertheless have such qualities that the comparisons with original exposures indicate the correct sub-image choices.

5. Segmental Variation-methods

Problems in common for the above-mentioned segmental methods include failure due to low contrast or picture areas lacking (sufficient) detail. Edges and pictur ntours may furthermore cause disturbances (artifacts), particularly along focus-edges while similar disturbances may appear along sub-image borders. The selection-methods are statistically more reliable when many image points (pixels) are involved within a particular sub-image. On the other hand, the selection process around focus-edges (i.e. edges which separate picture areas of differing states of focus) lacks precision when using large segments, due to the fact that such segments may land upon a focus-edge and as a result the segment-selection is, in such cases, bound to be in error for part of the segment, i.e. generally a more severe error for the larger sub-images. The segmental variation-method, is here the name coined for a general technique, where the object is to reduce such defects. Its characteristics are as follows:

Pixel-contents of the segments are changed by means of modifying their size, shape and position, thereby generating new (statistical) basic data for the segmental methods just described. One preferred mode is to change size of rectangular segments (like 2×2; 4×4; 8×8 . . . n×n pixels). Vertical and horizontal translations of one or several pixel intervals or rows, of a whole predefined segment-web, is another mode of preference, creating a sequence of differently positioned but otherwise similar segment-patterns. Some of the pixels, from each segment, will be replaced by other pixels from adjacent segments when performing these steps. However only a limited number of such web-translations are possible, without trivial repetition. For example: An ideal image without external boundaries is subdivided into segment squares (like 1×1; 2×2; 3×3; 4×4 or . . . n×n pixels), where the number of possible patterns N, without repetition of segment-contents, may be given as:

N=n×n (8)

The number of unique ‘different’ sub-image web-positions is thus 4×4=16, with the segment-squares sized 4×4 pixels, however all these permutations are not necessarily required for an image process. The selection procedure, according to any of the above-mentioned segmental techniques, may now be repeated as a whole for each of these web-positions and, as a result, several versions of a processed resultant image are created despite the fact that the same original exposures were the basis. For example, a pixel by pixel average from these resultant images may now be calculated, giving us the final image result, thus no longer founded upon a single ‘decision’ but rather upon a multitude of ‘decisions’, based on the more balanced and complete statistics, created by the different segment-patterns. This averaging does not affect, alter nor modify image regions with a stable and unambiguous state of focus, corresponding to one original image only. And this is because the averaging process takes place after the selection procedure. On the other hand, only those image-regions are influenced, where the choice in-between different original images is unstable, because of various reasons such as vicinity to focus-edges; Or in other words: Wherever a change of segment-size and position may influence the segment choice, this however not being the most general case. Averages from these ambivalent special cases reflect the uncertainty. This segmental variation technique does furthermore cause boundaries in-between adjacent segments/sub-images to change place. As a result, possible disturbances, discontinuities and other imperfections abate as the sub-images are moved around and averaged. A disadvantage of the segmental variation-technique might be it's time-consuming properties, due to repetition of the selection process.

6. Edge-methods

Image edges or contours are of at least two different kinds: Those caused by contrasts, i.e. strong intensity gradients (named ‘contrast-edges’ here) and those created by a boundary in-between image regions in different states of focus (named ‘focus-edges’ here). An edge may well be of both kinds, at the same time. As already mentioned, an ambivalent situation occurs whenever a segment falls upon a focus-edge. A way to avoid this is to find first those edges (for example with a laplacian analysis, already described) and then modify the sub-image division accordingly, wherever the sub-images happen to fall on such edges: For example by a further subdivision of the segments involved, into smaller sizes or by adjustment to more flexible shapes, so that these segments are distributed on either side of an edge, more or less. As a result, segment areas being influenced by focus-edges, are reduced. It's sometimes possible to have sub-images follow the shape of an edge.

A nearby focus-edges may, if being out of focus, obscure a background in focus, thus reducing image contrast along the focus-edge borders. This is essentially a perspective effect, as seen from the entrance aperture. The effect may be reduced by decreasing aperture, thereby reducing the width of this edge-zone.

Another remedy is to introduce a certain (relative) amount of electronic or optical magnification for proximity-focused images, so that focus-edges of foreground objects expand and, as a result, cover those zones with reduced contrast, more or less.

7. Segmental Exposure Control (SEC)

Another member of the image-improvement technique group, utilizing segments, here under the name ‘segmental exposure control’, shall now be described: A subdivision of original images into parts is presupposed even with this method. The purpose, according to another aspect of the present invention, is to improve the selection procedure for those picture areas, which would otherwise be over- or underexposed. The object is to control the exposures individually, i.e. for different segments, thus avoiding under- or overexposures and ensuring registration of more detail within the different sub-images. As a result, selection-methods with reference to depth of field are improved. It's a known fact that over- and underexposures of image-registering instruments (like film cameras, digital still photo and video cameras, image intensifier devices and infrared instruments), occur because the detectors (like CCD sensors, film emulsions or image cathodes), electronics (like A/D converters) and presentation media (like image screens and photographic paper) can only detect, process, respectively present a limited range of intensity ‘levels’ (cf. bandwidth) of incident light, through the optical entrance aperture. Or in other words, the front optics of an instrument may well project almost equally good images, regardless of high or low light level, while detectors, electronic processors and presentation media are more restricted in this respect, suffering from reduced capacity to represent the total light-intensity span or interval. The initial detection is of particular significance in that respect, because information being lost here, will irretrievably disappear even for the subsequent electronic process.

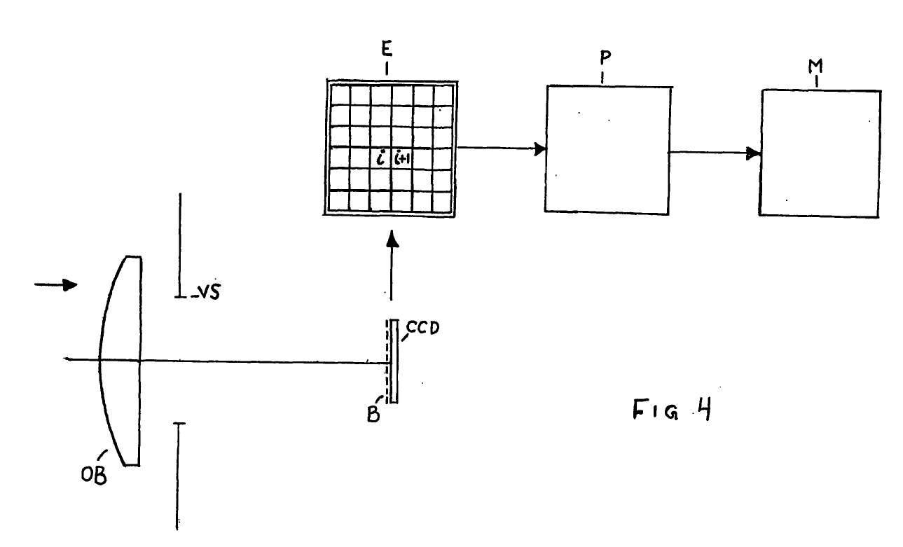

However, an optimal exposure for each little part of the whole image may be achieved by means of individual control of each part of the scene, i.e. by a differentiated variation of exposed amounts of light. As a result, each little part will be registered under a more favourable average intensity-level for the current sensor. The method is illustrated by FIG. 4.

Exposure control, according to this other aspect of the present invention does here, by definition, include a differentiated control of light-quantities exposed as well as spectral properties (white-balance), the latter quality also being subject to differentiated adjustments during detection or image processing, so that locally conditioned and troublesome tint-aberrations within for example sky regions or shadow areas are reduced or eliminated.

The varied and for some image-areas mixed lighting of light-sources with differing spectral character, like the sun or sky, incandescent or fluorescent lamps or flashlights may even create differing local states of white-balance on one and the same photo. The remedy is however a correction, using this ‘local’ technique. This procedure, of ‘segmental exposure control’ is exemplified as follows:

| | |
|---|---|
| 1. | As a first step, the local average light intensity for each little picture |
| | part or segment, is measured by means of a sensor belonging to the |
| | instrument. |
| 2. | The scene is exposed in such a way that each segment or individual |
| | picture-part is exposed/illuminated in the most optimal way. |
| 3. | Image processing, including possible depth of field-improvements |
| | according to the invention (cf. above), takes place. |
| 4. | The differentiated image-intensities are restored more or less, |
| | i.e. original (cf. step #1) average light intensities are recovered or, |
| | if applicable, are adjusted for presentation media. |

This last step #4 may involve a trade-off, namely a compression of the restoration in such a way that intensity-variations involved may fit within some constrained interval or ‘bandwidth’ of the presentation- or memory media available, so that image detail associated with exposure-extremes are not lost. This response may aim at a logarithmic or asymptotic behaviour, similar in character and function to an eye or emulsion-film.

The method of segmental exposure control was created in order to improve on the segmental selection process, where saturation situations occur when registering segments. In other words, where segments would otherwise be over- or underexposed to such a degree that image detail and contrast, projected by the entrance optics, is lost. Cloud formations of a bright sky may for instance ‘fade away’, or foliage inside a deep shadow may be ‘absorbed’ by darkness in the process of image registration.

Finally a discussion in more detail about how this selective exposure (cf. step #2 above) control may be arranged: Assuming (though the present invention not restricted to) a so called digital camera exposing more than one frame (like 2) of the same scene. First a standard exposure of—say—1/100 second, such as a ‘normal’ (prior art) automatic exposure control would dictate. Secondly a (comparatively) much underexposed picture with—say—1/400 second exposure time. We note that an extra 1/400 sec. exposure does not here significantly introduce extra motion blur as compared to the ‘normal’ 1/100 sec exposure. The execution may furthermore, in favourable cases, take place in fast succession, because no mobile components need to be involved. The other parameters like focusing, aperture stop, focal length etc are here remaining the same, for the two exposures. The point is that (otherwise) overexposed picture areas (like bright sky of a landscape scenery) are more appropriately exposed by means of the shorter exposure. The electronic camera processor may, after image registration, select such segments from either image, that are most optimal as regards exposure. And, because the sky is now retaining more detail on the frame subject to shorter exposure time, we may also expect the final picture to become more detailed. And as a consequence, it may be more reliably processed as far as depth of field-improving decision-methods of the present invention are concerned.

This differential exposure-method using sub-images, may continue to function and yield enhanced image quality, related to the same exposure-control improvements, even when the instrument/camera is restricted to register pictures, of one focal state only, i.e. whenever the depth of field-improvement function, according to an aspect of the present invention, has been ‘switched off’. And thus at last, as a spin-off from this discussion: It's evidently possible to apply this SEC image improvement technique to other independent contexts, i.e. even where instruments/cameras are lacking these depth of field-improvement facilities altogether.

The method does of course allow for more than 2 differently-exposed frames to be used, however practical limitations are there, as far as total exposure time is concerned and too many sequential and/or long exposure times may cause unacceptable motion blur at the end of the process. The method does also require more memory and calculation capacity, because more pictures must be processed as compared to ‘classic’ photography, according to present day technology and this does particularly apply to the combination with depth of field-enhancement imaging-techniques already discussed. However the performance of electronic processors and memories are presently undergoing a fast development which will presumably favour the present invention.

Related prior art and available technique, where the object is to achieve better exposure-control when taking a photo, include various kinds of optical filters (like for enhancement of cloud formations), camera settings for different types of scenes (snow-scapes, taling photos against the light etc) and the so called exposure-bracketing methods, where several differently-exposed photos are taken, in order to facilitate identification and choice of a preferable exposure. They all have in common that one state of exposure only is ‘allowed’ for each single photo. The segmental exposure control method on the other hand, as proposed here, involves several different states of exposure within one and the same final image-frame.

Existence of image sensors, with the specific property to allow for local variation of exposure time, provides us with one more technique for applying the differentiated exposure technique: This is where exposure time may be chosen in situ on the sensor, already during the process of detection. A sensor with differentially variable sensitivity (the equivalence of light sensitivity for photo emulsion-films) provides a similar mode. Another technique is to execute several exposures, using same exposure time, followed by some appropriate, controllable addition of these ‘contributions’ (pixel by pixel and/or for each segment) until an optimal ‘add-on’ average intensity has been reached for each individual segment. There is fmally one more way to control the amount of light exposed, i.e. by means of changing the relative aperture of the projecting lens: Several different exposures with same exposure time but different F-number, may now take place. They are executed with different aperture settings though, for instance during the process of one single and continuous aperture reduction. Several differently-exposed picture-parts or segments are thereby registered and optimally exposed segments may be selected as before, according to the principles already disclosed about the segmental exposure control technique.

All these applications may well show variations of practical interest, they are nevertheless all embracing the same basic principles which characterize this method of differentiated exposure control, i.e. the different image areas or segments of which the whole picture is built up, are subject to individual exposure.

8. Flash Photography

The depth of field-improvement technique, according to the present invention, does also call for a more optimal exposure control when illuminating a scene by artificial means. It's a well-known fact that flashlight, being used in photography, may severely flood the scene, ‘eroding’ the picture of foreground objects, still leaving the background utterly unilluminated, with a pitch dark appearance. This is due to the fact that light-intensity is quickly fading when receding from a light source. The exposure time is, according to well-known prior art, constituting an average of a sort, a compromise where certain objects of intermediate distance may be acceptably exposed while nearby objects become much overexposed and the background underexposed. The technique of exposure control, using segments, (cf. previous part #7) proves useful even for flash photography in combination with the depth of field-improving methods discussed. It's now possible, thanks to the differential exposure control, to choose in-between several differently exposed frames, for each state of focus (there being several or one only of the latter). For instance the following two exposures: First a 1/400 sec exposure, followed by a 1/100 sec standard one. At least part of the very foreground is ‘better’ reproduced by the first (1/400 sec) ‘shot’ while the second ‘normal’ one should give optimal exposure more or less, for intermediate distances. A state of focus corresponds to a particular focal distance, indicating an obvious possibility to link these two entities with a formula. And, assuming some pre-programmed knowledge about how the (flash) light-intensity is diminishing vs. range, we may let the camera calculate and decide about which one, of several differently-exposed frames, is most optimal for a certain focal distance.

The following method with differently-focused exposures (associated with certain distances, cf. above) and variable illumination, is applicable for the most common predetermined cases, where states of focus are known before exposure, and where the illumination of a scene is essentially artificial by means of flashlight or some other controllable floodlight or similar device on top, or in the vicinity of the camera. It's furthermore known how light intensity is fading with increasing focal distance, thus enabling calculation of the most optimal average illumination-levels, associated with respective states of focus. The illumination device may for example be designed so that the amount of light can be varied by electronic signals or other means via the camera/instrument, in such a way that the nearby-focused frames are exposed under less amounts of light, while the most distantly-focused images are exposed with more or sometimes all available light, depending upon the actual focal distances. Optimal flash intensities and/or exposure times, are thus set by actual object distances, which in turn are occasioned by pre-determined states of focus. Direct relationships in-between states of focus and optimal illumination-levels are thus established. The individual exposure control was here applied to each differently-focused image frame as a whole, while the object was to lose less image detail due to unsuitable exposure. As a final result, the depth of field-improvement techniques, where segment selection procedures apply, benefit from this technique.

9. Depth of Field Reduction Methods

The opposite effect to a depth of field-improvement, i.e. a depth of field-reduction, may prove useful, wherever the purpose is to enhance certain objects of the scene and where it is advantageous to suppress some annoying fore- or background, as may be the case in certain contexts. This process, aiming oppositely as compared to the before-mentioned depth of field-improvements, is nevertheless following same principles more or less, as evidenced by the following example:

| | |
|---|---|
| 1. | A ‘priority-image’ (j) is chosen by the operator. Objects being in |
| | focus, on this particular image, are to be enhanced. |
| 2. | An initial segment-selection procedure, following part #4 (above) will |
| | now take place. Optimally focused sub-images will thus be selected |
| | from the differently-focused images. |
| 3. | Those of the select segments (step #2) and furthermore belonging to |
| | (j) the priority-image only (step #1), are forwarded to a memory. |
| 4a. | A selection procedure ‘in reverse’ is next performed with the |
| | remaining segments: The most unfocused/blurred segments are thus |
| | selected and forwarded to memory. Or: |
| 4b. | A pixel by pixel summation-or some other kind of compound picture |
| | is made from the rest of the segments, optionally being subject to |
| | further blur by electronic means, finally forwarded to a memory. |
| 5. | A resultant image (R) is assembled from the optimally focused |
| | segments, belonging to priority image (j), according to step #3, |
| | plus the blurred segment contributions from #4a/b. |

Steps #4a/b may be varied and combined in different ways. The feature in common however, for these procedures, is the principle of first selecting picture parts, optimally focused, from a certain pre-select priority-image, thereafter in the most expedient way, choose and/or blur the rest of the segments, in order to degrade image definition for other regions of the composite final picture (R). This depth of field-reduction method may be regarded as a depth of field-filter, providing a variable depth of field restraint, around a priority-image: The priority state of focus (P) is surrounded on each side, by two differently-focused states (P+ and P−), according to a preferable mode of application: Thus, the available depth of field-interval becomes narrower as the object distances related to P− and P+ approach the priority-distance of P, from either side. Even segments selected from pictures, associated with P+ and P− may have fairly good image definition as such, being taken from the neighbourhood of some priority object in focus more or less, nevertheless appearing ‘blurred’ on the final step #5 picture (R), because of additional image blur being introduced by step #4a/b above. However, the two reference exposures P+ and P− should not be chosen too closely to priority-image P because the images would then become too similar and as a result, the ‘decision process’ according to steps #2-3 (above) would then suffer from a too high failure-frequency. This method is applicable for camera-viewfinders, when performing manual focusing or when a photographer wants to concentrate his attention on certain objects, in other words become as little distracted as possible by image-sharpness variations of other objects within the field of view. It's possible, according to another application, to simply replace the blurred segments from step #4 (above), with a uniform monochromatic RGB signature, like blue, thus placing the select objects of priority against a homogenous background without detail. A de facto separation from the fore- and background of select objects in focus, from a certain image #j, has thereby taken place in this specific case. It's also possible to replace the blurred sub-images from step #4 (above) with the corresponding segments from an entirely different picture, answering to a known want within the moving picture art, to create special effects, separating or merging various scenes.

10. Combination Methods

Conditions prevailing for Instruments and Cameras of the present invention, may vary considerably and particularly the scenes registered, exhibit such diverse character that it comes hardly as a surprise, if these methods proposed exhibit differing utility for various contexts or applications. Even image processing, of one and the same picture, may improve if allowing these methods to work together, interacting in a spirit of using each method where it performs best The contrast method for example is sensitive, thus suitable for sub-images of low contrast, while a template method may give fewer disturbances (artifacts), thus being more suitable for segments of high contrast The contrast-enhanced average method may prove more advantageous for a viewfinder, where image-quality conditions tend to be less severe, but where instead simplicity and speed are awarded. Plain summation- or average methods may be used whenever a viewfinder is purely optical and thus few other means are within sight, while apparently the segmental exposure control is most suitable in cases of large intensity variations across a scene (like when using flashlight or photographing against the light) and where (digital cameras) a considerable number of segments would be ‘saturated’, i.e. become over- or underexposed, if not using this technique. The segmental variation method can be used where the scene being reproduced is demanding, i.e. ‘problematic’ in a sense that unacceptably high failure-frequencies result from single selection- or iteration-rounds. Finally, the depth of field-reduction mode, may prove useful for cameras when selecting priority-focus through a viewfinder, a procedure likely to precede some depth of field-improvement process. The way these different methods are united by means of writing macro programs (*.bat files etc) is such a well-known engineering technique that there is no need here for repetition nor expanding upon the subject any further.

A careful pixel by pixel alignment of the differently focused/exposed images is presumed for all these above-mentioned multiple exposure-methods, this being the basis for all pixel by pixel comparisons and superpositions in the process. Side translations, twist or tilt of the images projected, in relation to the detection surface of the sensor(s) must therefore not take place while focusing or performing other movements. This is a matter of mechanical stability and tolerances of the instruments and cameras involved, more or less. Residual alignment errors may still influence the electronic image registration, however these errors can be detected and corrected by other means like some image correlation program, readily available (being prior art, cf. Swedish Patent #8304620-1). All these methods and application examples presented, being subject to multiple exposures of the same scene, are fundamentally related, following same basic principles, i.e. the object of them all is to manipulate the depth of field for an image in a most efficient way.

A final appropriate comment, concluding this survey of select-information processing, related to differently-focused/exposed original-image records, may therefore be that said methods, as described in above-mentioned parts #1-9, can be successfully combined in various ways.

What is claimed is

1. An electrooptical instrument having an objective lens for reproducing a scene composed of objects within a field of view at different object distances in front of said lens, a focusing device for setting said lens at various focal distances, at least one electronic image detector having an entrance plane for detection and record of image information corresponding to an image of said scene, an electronic image memory for storage of image information registered by said image detector and an image-sharpness detector, characterized by:
a/ The focusing device being arranged for simultaneous and/or time-sequential focusing of said instument at different object distances,
b/ the image detection being arranged in such a way that image information, corresponding to at least two differently-focused images, i.e. with differing states of focus, is recorded and
c/ means being assigned for having said image-sharpness detector geometrically and similarly subdivide said images into image parts or sub-images corresponding to each other in such a way that there are similar sub-images, from respective differently-focused images, depicting a similar part of said scene being reproduced and
d/ means being arranged for having said image-sharpness detector directly or indirectly, and from each set of said corresponding differently-focused sub-images, select and forward to image memory, that sub-image information contributing to optimal image resolution, and merge said select image information from corresponding image parts into a final image having better image resolution than each individually focused image record by itself.

2. An instrument of claim 1 characterized by means for measuring ranges with a range-finder, to parts of the scene in front of the objective lens.

3. An instrument of claim 2 characterized by a focal distance-sensor being part of the range-finder, and where said sensor is interacting with said image-sharpness detector in order to register those ranges for each part of the field of view, giving optimal image definition.

4. An instrument of claim 1 characterized by means being included with said image-sharpness detector, for detection of light intensity differences in-between adjacent zones of pixel detectors, located in each multiple of said sub-fields of view.

5. An instrument of claim 3 characterized by means for range-adjustnent registration, viz. related to said objective lens, and means for saving in memory such object distances recorded, giving optimal image resolution for each image part subdivided, and this resulting in a three-dimensional record of a scene in front of said lens.

6. An instrument of any previous claim characterized by the said image-detector device having several parts, and they each record images being projected by said objective lens, i.e. depictions of the same scene, albeit differing as regards focusing.

7. An instrument of claim 1 characterized by means being arranged for measurement of image contrast at each of said differently-focused sub-images and means being assigned for selecting and forwarding image information from such sub-images showing optimal contrast.

8. An electrooptical instrument or camera of claim 1 and said scene being illuminated with adjustable amounts of light by an artificial source of light, characterized by means being assigned for control and variation of said illumination in such a way that each image registration of said scene is subject to an illumination-intensity level, aiming at optimal exposure for that object distance linked to the state of focus, associated with said registration.

9. An electrooptical instrument of claim 1, characterized by means being arranged for production of a depth of field-improved template image, from said differently-focused images, this template being subdivided into image-parts or sub-images, like for said differently-focused images, and means being arranged for having the image-sharpness detector measure a similarity in-between each of said corresponding differently-focused image parts on one hand and the template-image equivalent part on the other, then select and forward image information from such sub-images being most similar to the corresponding template sub-images, and merge this select image information, originating from each set of differently-focused sub-images, into a final image with better resolution than each individually focused image record by itself.

10. An instrument of claim 1 characterized by means being assigned for repeating said subdivision of differently-focused images once or several times, however each time with differing subdivision and/or differing size/shape of said image parts or sub-images, so that different resultant images are generated from one and the same scene depicted, and that a compound average-image of sorts is created, preferably by means of a pixel by pixel fusion/superposition of said resultant images.

11. An electrooptical instrument with objective lens for reproducing a scene composed of objects within the field of view at different object distances in front of said lens, a focusing device for setting said lens at various focal distances, at least one electronic image detector with entrance plane for detection and record of image information corresponding to an image, i.e. the scene depicted, an electronic image memory for storage of image information registered by said image detector, an image-sharpness detector and an image-discriminatory device, characterized by:
a/ the said image-discriminatory device being arranged in order to enable a pre-selection of one or several priority-images,
b/ the focusing device being arranged for simultaneous and/or time-sequential focusing of said instrument at different object distances,
c/ the image detection being arranged in such a way that image information, corresponding to at least two differently-focused images, i.e. with differing states of focus, is recorded,
d/ means being assigned for having said image-sharpness detector geometrically and similarly subdivide said images into image parts or sub-images corresponding to each other in such a way that associated sub-images, from respective differently-focused images, depict the similar part of said scene being reproduced and
e/ means being arranged for having said image-sharpness detector, directly or indirectly from each set of said corresponding differently-focused sub-images, select and forward such image information, contributing to optimal image resolution in the first place and belonging to said priority-images selected in the second place and
f/ means being assigned for having the image-sharpness detector, directly or indirectly from said set of image parts, except for those parts already chosen/forwarded from step e/, select and forward other sub-image information contributing to inferior image definition and
g/ means for optional image defocusing being arranged, enabling possible further image definition degradation of said select image information from step f/, and
h/ means being arranged for assembling said image information from steps e/, f/ and optionally g/ to a final image having inferior depth of field-properfies than each individually-focused image record by itself.

12. An instrument of claim 11 characterized by said image parts from step f/ being exchanged for corresponding image-parts from another image.

13. An electrooptical instrument or camera with objective lens for reproducing a scene composed of field of view-objects in front of said lens, an adjustable exposure device for setting the state of exposure, as defined by exposure time, relative aperture and sensor sensitivity in various combinations, and at least one electronic image detector with entrance plane for image detection, viz. image-information corresponding to said scene being recorded, and an exposure meter, characterized by:
a/ means for subdivision of images recorded and of associated detector plane, into patterns of sub-images viz. corresponding sensor-parts and
b/ means for having said exposure meter measure and register, for each said sub-sensor area, the light intensity projected by said objective lens, thus enabling estimates about which states of exposure are generating the most optimal light projection on each individual sensor-part and
c/ means for exposing each of said sub-images, thereby registering each part individually, under a state of optimal exposure more or less according to step b/ decisions for each image part and
d/ means for performing electronic image processing including restoration of originally projected light levels on respective sensor-parts and, if applicable, limited capacity of memory- and/or presentation media necessitating further adjustments.

14. An electrooptical instrument or camera of claim 13 characterized by an image detection with
a/ means being arranged for recording image information corresponding to at least two differently-exposed images, i.e. with differing states of exposure,
b/ means being arranged for performing said image subdivision similarly for the different images, in such a way that corresponding sub-images from each differently-exposed image, depict the similar part of said scene reproduced and
c/ means being arranged for said exposure meter to select and forward from each set of said corresponding albeit differently exposed sub-images, that sub-image information corresponding to the most optimal states of exposure, i.e. contributing to the best detail-reproduction in the process of image registration, and merge this select sub-image information from each set of corresponding sub-images into a fmal image having better image detail-reproduction than each individually exposed image record by itself.

15. An electrooptical instrument or camera of claim 13 characterized by further means being arranged for performing an image processing of whichever claim 1-12 and 17, creating depth of field-improved final images.

16. An electrooptical instrument or camera of claim 13, characterized by means being arranged for an image processing where colour- and/or white-balance of said image parts or sub-images of the resultant image, are adjusted individually.

17. An electrooptical instrument or camera having an objective lens for reproducing a scene composed of field of view-objects at different object distances in front of said lens, a focusing device for setting said lens at various focal distances, at least one electronic image detector having entrance plane for detection and record as image information of the scene, viz. as a picture, and an electronic image memory for storage of image-detector information being registered, characterized by
a/ means being assigned for simultaneous and/or time-sequential focusing of said instrument at different object distances and
b/ image registration being arranged in such a way that image-information, corresponding to at least two differently-focused images, i.e. with differing states of focus, is recorded and
c/ the differently-focused images being arranged for superposition into a compound image (M) and
d/ means being arranged for defocusing said compound image (Mb), and
e/ image intensity of said (Mb) image being arranged for a pixel-by-pixel reduction, by a factor k (Mbk) and finally
f/ a pixel-by-pixel subtraction of said image (Mbk) from said compound image (M) being arranged, giving a resultant final image (S) having better image definition and depth of field-properties than each individually focused image record by itself.

18. A method for photographing a scene in front of an objective lens of a camera, recording taking place via a detector-plane and registration being executed with the camera set to a plurality of differing focal distances, characterized in that the differently registered records are zonally subdivided in a mutually similar way, so that for each zone is arising a plurality of sub-images corresponding to said plurality of focal adjustments, and in that a final image is assembled by means of selecting that sub-image from the sub-images in each zone, showing the best image definition.

19. The method of claim 18 characterized in that said recordings are executed in one context while said subdivision into sub-images and assembly of the same sub-images is taking place in another context and at another place.

20. The method of claim 18 characterized by a registration-procedure where a firstly-registered image record is transferred to an image-memory, and a subsequent recording is compared sub-image by sub-image to the one present in the image memory, whereby that sub-image of the two having the better image definition, is selected, being retained in the image memory, and said method-steps being iterated for subsequent images recorded, so that the resulting final image ends up in said image memory.

21. An electrooptical instrument or camera having a depth of field-modifying function, with objective lens for depicting a scene composed of field of view-objects at various object distances in front of said objective lens, and having a focusing device for setting said objective lens and having an image-registration device, characterized by:
a/ said focusing device being arranged for focusing the instrument at differing object distances,
b/ said image detection being arranged in such a way that image information, equivalent to at least two differently-focused images, i.e. having differing states of focus, is recorded and
c/ means being assigned for using differing states of magnification when performing image registration and/or processing of said differently-focused images.
